(19) United States
(12) Patent Application Publication
(10) Pub. No.: US 2013/0327235 A1
(43) Pub. Date: Dec. 12, 2013

(54) FOIL UNWINDING DEVICE FOR STAMPING MACHINE

(71) Applicant: Jean-Claude Rebeaud, Le Mont (CH)

(72) Inventor: Jean-Claude Rebeaud, Le Mont (CH)

(73) Assignee: BOBST MEX SA, MEX (CH)

(21) Appl. No.: 14/001,217

(22) PCT Filed: Feb. 15, 2012
(86) PCT No.: PCT/EP12/00654

§ 371 Date: Aug. 23, 2013

(30) Foreign Application Priority Data
Feb. 28, 2011 (EP) 11001601.1

(51) Int. Cl. B44B 5/00; B65H 23/182

(52) U.S. Cl. CPC B44B 5/0004; B65H 23/182
USPC 101/3.1; 242/417

(57) ABSTRACT

A device 100 for unwinding foil to accumulate at least one stamping foil 20 upstream of an advance shaft 50. The device 100 includes two series 110, 120 of diverting elements 111, 121. One series is mobile relative to the other to define a foil circulation path of variable length. The mobile series moves between a close together position and a far apart position as the foil advances. A movement device 130 moves the mobile elements 110 as a function of a variable rotation speed difference between an advance shaft 50 of the foil that turns at variable speed and a rotary drive member 131 that turns at a constant speed substantially at the average rotation speed of the advance shaft 50. A transmission between the shaft 50 and the member 131 enables them to rotate at variable and constant speeds.

The present invention concerns a device enabling stamping foil to be paid out with a view to storing it temporarily before its actual use in a stamping machine.

The invention finds a particularly advantageous, but not exclusive, application in the field of the fabrication of packaging for luxury goods.

It is known to print texts and/or patterns by stamping, that is to say by depositing by pressure on a support in the form of a sheet colored or metalized foil coming from one or more stamping foils commonly called metalized foils. In the industry, such a transfer operation is usually carried out by means of a platen press into which the printing supports are introduced sheet by sheet, while each stamping foil is fed continuously.

Each stamping foil is traditionally stored in the form of a spool, and it is a advance shaft that pays it out and circulates it through the stamping machine. In practice, this advance shaft is required to turn at variable speed given that in a platen press, by definition, the foil is fed sequentially. In concrete terms, this means that the rotation of the advance shaft consists in a more or less complex combination of accelerations, decelerations and time-delays.

The problem with this kind of arrangement is that it does not enable precise unwinding of the foil. A spool of stamping foil has a non-negligible mass and thus a relatively high inertia. It therefore proves particularly difficult for such a spool to track the succession of accelerations, decelerations and time-delays that is imposed by the advance shaft. This being so, it will not be possible to advance the stamping foil with the required precision, which in the end inevitably degrades the quality of the stamping. In other words, although it is preferable for a foil to be paid out at a substantially constant speed given the inertia of the spool that supports it, this is not compatible with the fact that the same foil is intended to circulate sequentially when acted on by a advance shaft turning at variable speed.

To solve this problem, it is possible to constitute a reserve of foil upstream of the advance shaft. In this regard, there is notably known a foil unwinding device that is placed between the spool and the advance shaft and that uses two series of diverting elements, the distance between which may vary as the foil advances. In concrete terms, the two series of diverting elements are disposed substantially face to face in such a manner as to define a foil circulation path the shape of which describes a succession of loops that respectively circumvent each diverting element on passing alternately from one series of diverting elements to the other. One of the series of diverting elements is mounted to be mobile relative to the other between a close together position in which the series of diverting elements are disposed in the vicinity of each other to define a foil circulation path of minimum length and a far apart position in which said series of diverting elements are disposed at a distance from each other in such a manner as to define a foil circulation path of maximum length. The foil unwinding device further includes means adapted to move the series of mobile diverting elements between the close together position and the far apart position as a function of the advance of the foil that is actually driven by the rotation of the advance shaft.

However, this type of foil unwinding device has the drawback that its operation is not free of jerks, notably during transient starting and stopping phases, but also during acceleration and deceleration phases. The unfortunate consequence of this is to limit the stamping speed of the platen press.

Thus the technical problem to be solved by the subject matter of the present invention is to propose a device for unwinding foil to accumulate at least one stamping foil upstream of a advance shaft, said device including on the one hand two series of diverting elements one of which is mounted to be mobile relative to the other between a close together position and a far apart position in such a manner as to define a foil circulation path of variable length and on the other hand means adapted to move the series of mobile diverting elements between the close together position and the far apart position as a function of the foil advance, which device would make it possible to avoid the problems of the prior art, notably by offering significantly more regular operation.

The solution in accordance with the invention to the stated technical problem consists in that the movement means are adapted to move the series of mobile diverting elements as a function of the rotation speed difference between the advance shaft that is intended to turn at variable speed and a rotary drive member that is meant to turn at a constant speed substantially equal to the average rotation speed of said advance shaft.

It is to be understood that throughout the present text the term diverting element generally designates any element capable of diverting the circulation of a foil. It may notably be static, such as an air diverting element, or intrinsically mobile, such as a rotary roller.

For its part, the concept of a series of diverting elements encompasses the situation in which there is only one diverting element, even though in practice the use of a plurality would be quasi-systematic. In concrete terms, the number of diverting elements will be chosen first and foremost as a function of the quantity of foil to be placed temporarily in reserve.

It is to be noted that the device of the invention for unwinding foil may be installed anywhere enabling both reception of the stamping foil coming from its place of storage and delivery of foil to the advance shaft associated with it. This notably means that this kind of foil unwinding device may equally well be positioned inside or outside the machine.

It is also important to point out that the foil unwinding device of the invention may equally well be associated with a single stamping foil driven by its own advance shaft or a plurality of foils coupled to a common advance shaft.

Be this as it may, the invention as so defined enables the prior art problem of jerks to be overcome, and thus real flexibility of operation to be achieved. It is consequently possible to operate the platen press at much higher throughputs than its prior art counterparts.

The present invention further concerns the features that will emerge during the following description considered separately and in all technically possible combinations.

This description, given by way of nonlimiting example, is intended to explain in what the invention consists and how it may be practised. The description is moreover given with reference to the appended drawings, in which:

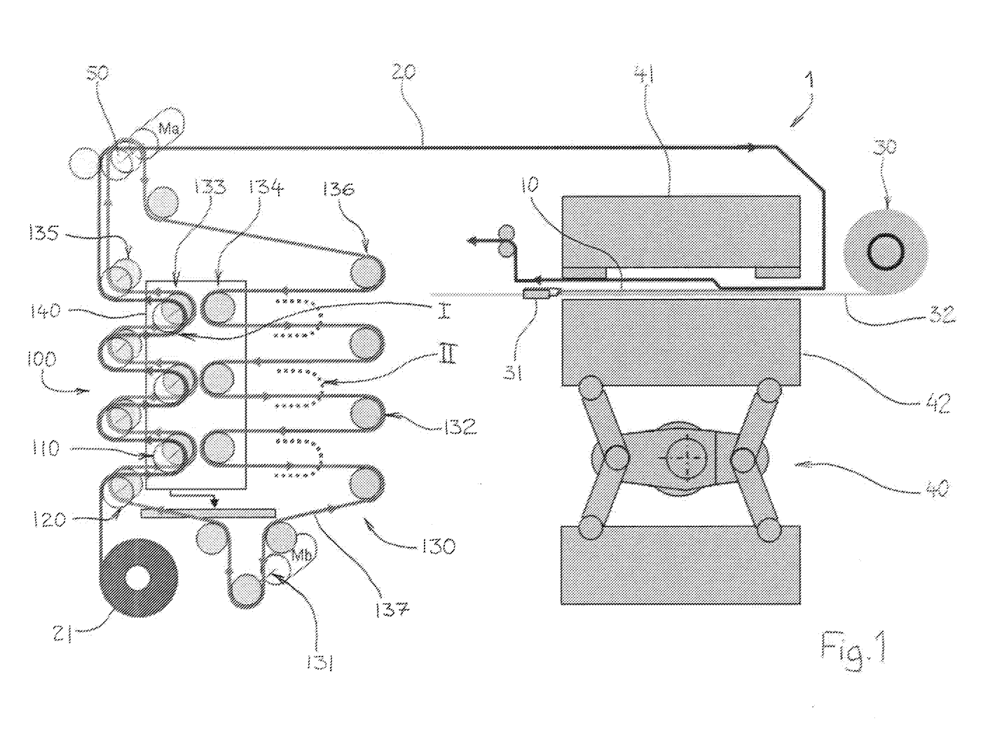

FIG. 1 shows a stamping station incorporating a foil unwinding device of the invention.

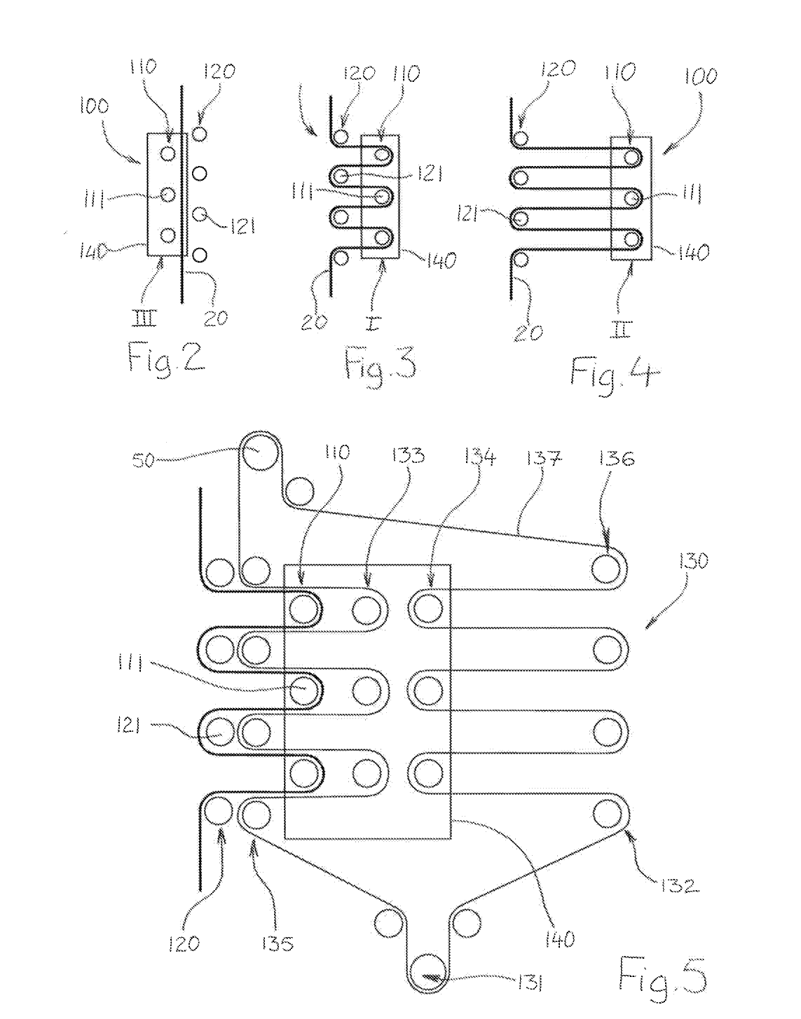

FIG. 2 is a diagrammatic representation of the foil unwinding device in a so-called loading position.

FIG. 3 constitutes a view analogous to FIG. 2 but with the foil unwinding device in a close together position.

FIG. 4 is a view similar to FIGS. 2 and 3 but with the foil unwinding device in a far apart position.

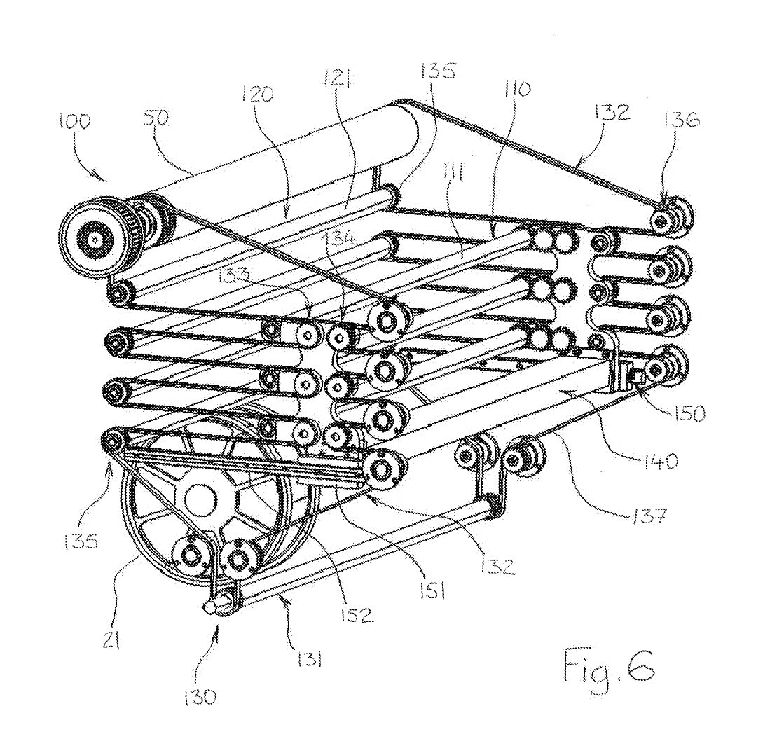

FIG. 5 is a diagrammatic representation of details of the structure of the displacement means with which the FIG. 1 foil unwinding device is equipped.

FIG. 6 is a perspective view of one concrete embodiment of a foil unwinding device of the invention.

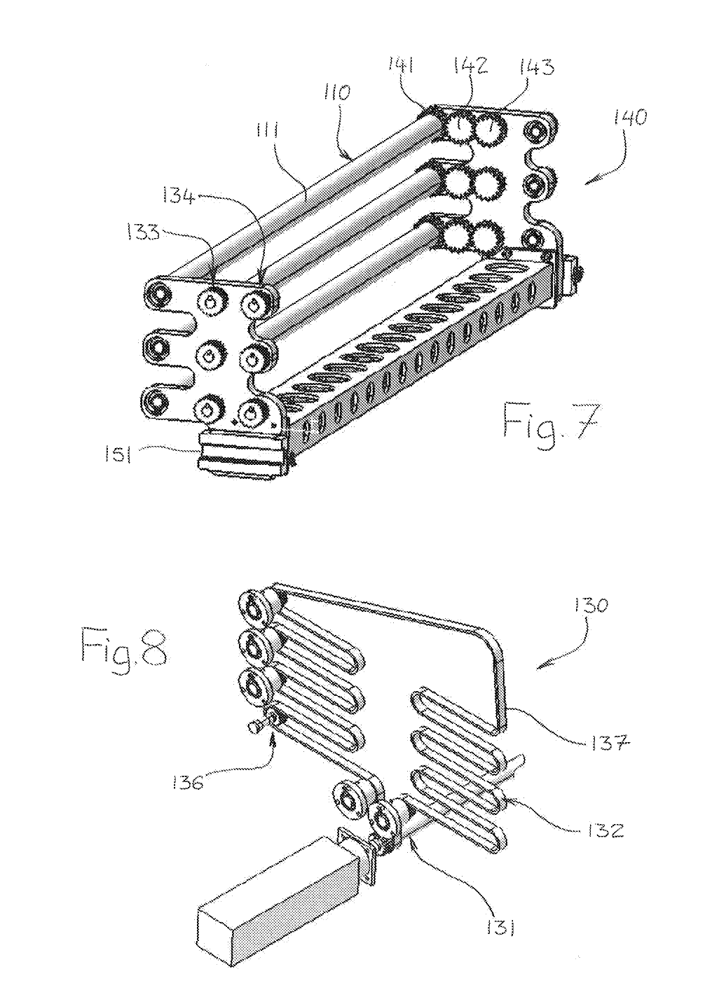

FIG. 7 shows in detail the mobile part of the foil unwinding device shown in FIG. 6.

FIG. 8 shows the part of the foil unwinding device that drives movement of the mobile part shown in FIG. 7.

For reasons of clarity, the same elements have been designated by identical references. Similarly, only elements essential for understanding the invention have been shown, diagrammatically and not to scale.

FIG. 1 shows a stamping station 1 that is intended to equip a printing machine for depositing foil on cardboard packaging. Such a printing machine, commonly called a foil blocking machine, is perfectly well known in the prior art. It will therefore not be described in detail here, in terms of either its structure or its operation.

It will simply be pointed out that it is typically composed of a plurality of workstations that are juxtaposed to form a unitary assembly capable of processing a succession of printing supports in the form of sheets 10. Thus there are usually a feeder responsible for feeding the machine sheet by sheet, a feed table on which the sheets 10 are placed in a layer before being precisely positioned individually, a stamping station 1 adapted to deposit on each sheet 10 by hot stamping metalized foil coming from at least one foil 20, a waste recovery station for evacuating each spent stamping foil 20, and a delivery station adapted to restack the sheets previously processed. Conveying means 30 are further provided for moving each sheet 10 individually from the exit of the feed table to the receiving station, including through the stamping station 1. In an entirely standard manner, these conveying means 30 employ a series of clamp bars 31 that are mounted to be mobile transversely in translation via two trains of chains 32 disposed laterally on each side of the printing machine.

In this particular embodiment, chosen entirely by way of example, the sheets 10 are stamped by means of a standard platen press 40, to be more precise between an upper heating platen 41 that is fixed and a lower platen 42 that is mounted to be mobile to-and-fro vertically. Moreover, and in order to simplify an understanding of the invention, the stamping station 1 is here fed with only one stamping foil 20 wound around a spool 21 and driven by a advance shaft 50.

FIG. 1 also shows that the stamping station 1 further incorporates a foil unwinding device 100 for accumulating stamping foil 20 in a pre-paid-out form upstream of the advance shaft 50.

This foil unwinding device 100 comprises two series 110, 120 of diverting element rollers 111, 121 that are positioned substantially face to face. Everything is arranged so that these two series of diverting elements 110, 120 define a foil circulation path the shape of which describes a succession of loops that respectively circumvent each diverting element 111, 121 on passing alternately from one series of diverting elements 110 to the other series of diverting elements 120. Moreover, one series of diverting elements 110 is mounted to be mobile in translation relative to the other series of diverting elements 120. This mobility is operative between, on the one hand, a close together position I (FIG. 3) in which the series of diverting elements 110, 120 are placed in the vicinity of each other in such a manner as to define a foil circulation path of minimum length and, on the other hand, a far apart position II (FIG. 4) in which said series of diverting elements 110, 120 are disposed at a distance from each other in such a fashion as to define a foil circulation path of maximum length. Finally, the foil unwinding device 100 has movement means 130 adapted to drive movement in translation of the series of mobile diverting elements 110 between the close together position I and the far apart position II, as a function of the advance of the foil that is actually driven by the rotation of the advance shaft 50.

According to the present invention, the movement means 130 are adapted to move the series of mobile diverting elements 110 as a function of the rotation speed difference between the advance shaft 50 that is intended to turn at variable speed and a rotary drive member 131 that is meant to turn at a constant speed substantially equal to the average rotation speed of said advance shaft 50.

At this stage of the description, it is to be understood that the movement in translation of the series of mobile diverting elements 110 between the close together position I and the far apart position II may in theory take place along any trajectory. A rectilinear or curvilinear trajectory is notably considered here, and more generally any trajectory resulting from any combination of these two types of movement in translation.

According to another feature of the invention, the diverting elements 111, 121 of each series 110, 120 are separated transversely in pairs by empty spaces the dimensions of which are greater than those of the diverting elements 111, 121 of the other series 110, 120. This feature is intended to allow the diverting elements 111 of the mobile series 110 to pass between the diverting elements 121 of the static series 120. In this line of thinking, the series of mobile diverting elements 110 is moreover mounted to be mobile in translation between the close together position I (FIG. 3) and a loading position III (FIG. 2) in which said series of mobile connectors 110 is on the other side of the series of static diverting elements 120 compared to the place that it occupies in the close together position I. Everything is arranged in such a manner that the diverting elements 111 of the mobile series 110 move between the close together position I and the loading position III along a trajectory causing them to pass between the diverting elements 121 of the static series 120.

In an analogous manner to what has been stated above, any type of trajectory may be envisaged a priori for the movement in translation of the series of mobile diverting elements 110 between the close together position I and the loading position III.

Be this as it may, such an arrangement greatly facilitates placing the foil 20 in the unwinding device 100. It suffices to cause the series of mobile diverting elements 110 to move to the other side of the series of static diverting elements 120, and then to insert the foil 20 linearly between said series of diverting elements 110, 120 (FIG. 2), before moving the series of mobile diverting elements 110 back through the series of static diverting elements 120 to its initial position (FIG. 3). This therefore avoids the need to form the succession of loops around the various diverting elements 111, 121 manually, which represents a valuable saving in time.

In a particularly advantageous manner, the mobile diverting elements 111 are here disposed directly facing the empty spaces between the static diverting elements 121, both in the close together position I and in the loading position III. Everything is moreover arranged in such a fashion that the mobility in translation of the series of mobile diverting elements 110 between the two positions in question is along a substantially rectilinear trajectory.

The benefit of such an embodiment essentially lies in its simplicity. By offsetting the mobile diverting elements 111 transversely relative to the static diverting elements 121, the series of mobile diverting elements 110 is ideally positioned to be moved in a straight line. Such an operation proves particularly easy to carry out, given that a rectilinear movement in translation constitutes a movement that is relatively simple to generate and to guide.

The two series of diverting elements 110, 120 preferably lie in respective substantially parallel positioning planes. Everything is moreover arranged in such a manner that the mobility in translation of the series of mobile diverting elements 110 between the close together position I and the far apart position II, just as between said close together position I and the loading position III, is in a direction substantially perpendicular to said positioning planes.

The fact that the two series of diverting elements 110, 120 lie in two substantially parallel planes means on the one hand that the diverting elements 111, 121 of the same series 110, 120 are substantially coplanar and on the other hand that the corresponding two planes are equidistant. For its part the fact that the mobility in translation of the series of mobile diverting elements 110 is perpendicular to the two positioning planes implies that the mobile diverting elements 111 are offset transversely relative to the static diverting elements 120 and that they move in a straight line.

According to another feature of the invention, the series of mobile diverting elements 110 is fastened to a mobile support, forming a oscillatory member 140. Everything is moreover arranged in such a manner that the movement means 130 are in a position to move the oscillatory member 140 both between the close together position I and the far apart position II and between said close together position I and the loading position III.

In this line of thinking, the foil unwinding device 100 advantageously has guide means 150 that, as their name indicates, are adapted to guide movements of the oscillatory member 140 between the close together position I and the far apart position II, as well as between said close together position I and the loading position III.

As may be seen clearly in FIG. 6, the guide function is provided here on each side of the oscillatory member 140. The guide means 150 employ two carriages 151 fixed on respective opposite sides of the oscillatory member 140 and each of which cooperates sliding fashion with a fixed and rectilinear guide rail 152.

According to another feature of the invention, the movement means 130 are adapted to move the series of mobile diverting elements 110 and the series of static diverting elements 120 closer together when the instantaneous rotation speed of the advance shaft 50 exceeds the average rotation speed of that same advance shaft 50, but also to move said series of mobile diverting elements 110 away from series of static diverting elements 120 when said instantaneous rotation speed falls below said average rotation speed.

In a particularly advantageous manner, the movement means 130 employ a rotary drive member 131 that is coupled to the oscillatory member 140 via at least one indirect transmission member 132 forming a differential. Everything is moreover arranged in such a manner that each transmission member 132 is also coupled in driving manner with the advance shaft 50. It is to be noted that in the context of the invention the term differential designates any mechanism capable of coupling in a driving manner rotary elements turning at different speeds. In the present instance, it is a question here of the advance shaft 50 that is intended to turn at variable speed and a rotary drive member 131 that is meant to turn at constant speed.

In the concrete embodiment of FIGS. 6 to 8, the movement means 130 employ two transmission members 132 placed on each side of the oscillatory member 140. Each transmission member 132 comprises a first series of pulleys 133 and a second series of pulleys 134, called mobile series 133, 134, which are respectively installed behind and in front of the oscillatory member 140, a first series of pulleys 135 and a second series of pulleys 136, called static series 135, 136, which are installed on fixed parts of the unwinding device 100, which are respectively situated behind and in front of the oscillatory member 140, and a flexible transmission element 137. Everything is arranged in such a manner that each flexible transmission element 137 describes on the one hand a first succession of loops (FIGS. 5 and 8) that respectively circumvent each pulley of the first static series 135 and the first mobile series 133, passing alternately from one series to the other, and on the other hand a second succession of loops (FIGS. 5 and 8) that respectively circumvent each pulley of the second static series 136 and the second mobile series 134, passing alternately from one series to the other. Finally, each flexible transmission element 137 cooperates in driving manner both with the rotary drive member 131 and with the advance shaft 50.

It is to be understood here that the terms “front”, “rear”, “in front”, “behind” are to be understood relative to the direction of movement of the oscillatory member 140 and considering the forward direction as that which corresponds to the series of mobile diverting elements 110 moving away from the series of static diverting elements 120.

In this embodiment, the flexible transmission element 137 is constituted by a notched belt. It is nevertheless possible to use a smooth belt, a chain, a cable, etc.

When the advance shaft 50 turns at the same speed as the rotary drive member 131, the oscillatory member 140 remains immobile in a substantially central position relative to the first series of static pulleys 135 and the second series of static pulleys 136. This is on the understanding that the oscillatory member 140 can move only when the instantaneous rotation speed of the advance shaft 50 is different from its average speed.

Thus as soon as the rotation speed of the advance shaft 50 is about to exceed that of the rotary drive shaft 131, the belt portion 137 situated directly upstream of said advance shaft 50 pulls the oscillatory member 140 backward, i.e. in the direction of the series of static diverting elements 120. The mobile diverting elements 111 will then move toward the static diverting elements 121, thus enabling quick release of the required quantity of pre-paid-out foil 20.

On the other hand, when the advance shaft 50 is about to decelerate, its rotation speed will end up by falling below that of the rotary drive member 131. Each belt portion 137 situated directly upstream of said drive member 131 will then tend to pull the oscillatory member 140 forward, toward its initial central position. The consequence of this will be to generate movement of the mobile diverting elements 111 away from the static diverting elements 121 and therefore progressive reconstitution of the stock of pre-paid-out foil 20.

Thus the direction of movement of the oscillatory member 140 will depend on the evolution over time of the speed of the advance shaft 50, in other words whether it is a matter of acceleration or of deceleration. The speed of movement of the oscillatory member 140 will for its part be proportional to the intensity of the acceleration or the deceleration generated by the advance shaft 50. For its part, the amplitude of the movement of the oscillatory member 140 will be linked to the duration of the phase of acceleration or deceleration of the advance shaft 50, and thus the quantity of foil 20 actually in play.

According to another advantageous feature of the invention, each diverting element 111 of the series of mobile diverting elements 110 is coupled in rotary driving manner with a pulley of each first series of mobile pulleys 133 (FIGS. 1 and 7). Moreover, each diverting element 121 of the series of static diverting elements 120 is coupled in rotary driving manner with a pulley of each first series of static pulleys 135 (FIGS. 1 and 6). These features enable the diverting elements 111, 121 to be made to turn at the same speed as the advance shaft 50. The objective is to avoid any phenomenon of slippage between the foil 20 and the diverting elements 111, 121.

In this embodiment, as shown in FIG. 6, each static diverting element 121 is directly coupled in rotation with the corresponding static pulley 135. On the other hand, and as may clearly be seen in FIG. 7, the rotational coupling between each mobile diverting element 111 and the corresponding mobile pulley 133 is achieved indirectly via a cascade of gears 141, 142, 143 of which the two end gears 141, 143 are respectively fastened to said mobile diverting element 111 and said mobile pulley 133. The presence of the cascade of gears 141, 142, 143 enables the driving function to be provided at the same time as obtaining an eccentric position of the mobile diverting elements 111 relative to the mobile pulleys 133. The final objective is obviously to be able to move the series of mobile diverting elements 110 into the loading position.

Of course, the invention is equally concerned with any stamping station 1 that is capable of depositing colored or metalized foil coming from at least one stamping foil 20 onto a succession of elements in the form of sheets 10 and that includes at least one foil unwinding device 100 as described above.

More generally, however, the invention further relates to any machine for processing elements in the form of sheets 10 that includes a stamping station 1 able to deposit on each sheet 10 colored or metalized foil coming from at least one stamping foil 20 and that further includes at least one foil unwinding device 100 as described above.

1-12. (canceled)

13. An apparatus for unwinding a foil to accumulate at least one stamping foil, the apparatus comprising:
an advance shaft positioned and configured for advancing the at least one stamping foil through the apparatus and for causing accumulation of the stamping foil upstream of the advance shaft; the advance shaft is configured to turn at variable speed while advancing the stamping foil;
first mobile foil diverting elements, second non-movable diverting elements which are non-movable relative to movement of the first mobile diverting elements, wherein the first and second diverting elements are mounted in the apparatus so that at least the first mobile elements are movable relative to the second non-movable elements between a close together position and a far apart position for defining a circulation path for the foil, the circulation path is of variable length as the first elements move relative to the second elements and the foil is advanced through the apparatus;
a moving device connected with the first mobile diverting elements, the moving device is configured and operable for moving the first mobile diverting elements between the close together position and the far apart position as the foil is advanced through the apparatus;
a motion transmission connected between the advance shaft located at an entrance side to the diverting elements and a rotary drive member at the transmission after the series of diverting elements and after the passage of the foil past the diverting elements and through the apparatus, wherein the advance shaft is configured and operable for turning at a variable speed for driving the transmission at a variable speed, and the rotary drive member is configured and operable to turn at a constant speed that is substantially an average rotation speed of the advance shaft; and
the moving device moves the first mobile diverting elements between the positions as a function of the rotation speeds of the advance shaft and the rotary drive member.

14. The apparatus of claim 13, wherein each of the first mobile diverting elements and the second non-movable diverting elements are arranged in respective rows thereof, the row of the first diverting elements is separated from and movable with respect to the row of the second diverting elements; the diverting elements in each of the first and second rows are separated along their respective row in respective pairs of the first diverting elements and of the second diverting elements to define empty spaces between each pair of diverting elements in each row, wherein the spaces between each pair of the diverting elements in each row are dimensioned to be greater than the dimension of the diverting elements along the respective other row of the diverting elements, whereby one of the first and second diverting elements may pass between a pair of the other of the first and second diverting elements;
the first mobile diverting elements are supported and operable to be movable with respect to the second non-movable diverting elements along a path between the close together position and a further loading position; in the loading position, the first mobile diverting elements have been moved to be disposed on the other side of the second diverting elements relative to a plane that the row of second diverting elements occupy when the diverting elements are in the close together position; and
the movement of the first diverting elements between the close together position and the loading position is according to a structure of the apparatus along a trajectory for causing each of the first diverting elements to pass between a respective pair of the second diverting elements.

15. The apparatus according to claim 14, wherein the close together position and the loading position of the first diverting elements are both disposed facing the empty spaces between a respective pair of the second diverting elements.

16. The apparatus according to claim 15, wherein the movement of the first diverting elements between the closed together position and the loading position is along a substantially rectilinear trajectory.

17. The apparatus according claim 15, wherein the first and the second diverting elements lie in respective substantially parallel positioning planes, such that movement of the first diverting elements between the close together position and the far apart position and between the close together position and the loading position is in a direction substantially perpendicular to the respective positioning planes.

18. The apparatus according to claim 13, further comprising a mobile support, to which the first mobile diverting elements are fastened, wherein the mobile support comprises an oscillatory member movable in an oscillatory manner; and
the movement device is configured and operable to move the oscillatory member between the close together position of the first diverting elements and the far apart position of the first diverting elements.

19. The apparatus of claim 18, wherein the movement device for the oscillatory member is configured and operable for moving the oscillatory member to move the first diverting elements between the close together position and the loading position.

20. The apparatus of claim 18, further comprising a guide device configured, oriented and operable to guide the movement of the oscillatory member between the close together position and the far apart position of the first diverting elements and optionally between the close together position and the loading position of the first diverting elements.

21. The apparatus of claim 20, wherein the movement device is configured and operable to move the first diverting elements in a direction toward the second diverting elements when an instantaneous rotation speed of the advance shaft is measured to exceed an average rotation speed of the advance shaft and to move the first diverting elements away from the second diverting elements when the instantaneous rotation speed of the advance shaft is measured to be less than the average rotation speed of the advance shaft.

22. The apparatus of claim 13, wherein the movement device includes the rotary drive member and the transmission, the transmission comprises a transmission element that couples the rotary drive member to the oscillatory member of the first diverting elements, and the transmission element is configured such that the transmission element forms a rotation differential for the different respective rotations of the rotary drive member and the advance shaft, and the transmission element is coupled in driving manner with the advance shaft.

23. The apparatus of claim 22, further comprising:
the transmission further comprises a first mobile series of pulleys respectively installed at the oscillatory member; and
a second static series of pulleys installed at fixed locations on the apparatus, and the second series of pulleys are respectively situated at a different location at the oscillatory member than the first series of pulleys;
the transmission element is flexible so that as it passes over the first mobile diverting elements, it adopts a first succession of loops that respectively circumvent each of the second static series of pulleys and then in sequence circumvents the successive pulley of the first mobile series of pulleys, and repeats that sequence, whereby the flexible transmission element passes alternately from one of the series of pulleys to the other of the series of pulleys; and
the flexible transmission element cooperates in driving manner with the rotary driving member and with the advance shaft.

24. The apparatus of claim 23, further comprising each of the first mobile diverting elements is coupled in rotary driving manner with a respective pulley of the first series of mobile pulleys, and each of the second static diverting elements is coupled in rotary driving manner with a respective pulley of the second static pulleys.

25. An apparatus of claim 13, wherein the movement device is configured and operable to move the first mobile diverting elements in a direction toward the second static diverting elements when an instantaneous rotation speed of the advance shaft is measured to exceed an average rotation speed of the advance shaft and to move the first mobile diverting elements away from the second static diverting elements when the instantaneous rotation speed of the advance shaft is measured to be less than the average rotation speed of the advance shaft.

26. The apparatus of claim 22, wherein the transmission further comprises:
a first and a second mobile series of pulleys respectively installed behind the oscillatory member and in front of the oscillatory member with respect to the movement of the oscillatory member in a first direction;
a first and a second static series of pulleys installed on fixed parts of the apparatus so that the mobile series of pulleys move with respect to the static series of pulleys;
the first and second static series of pulleys are respectively located behind and in front of the oscillatory member;
the transmission element is flexible for forming a first succession of loops of the transmission element that respectively circumvent each pulley of the first static series and then each pulley of the first mobile series, and so forth, with the transmission element passing alternately from the first mobile series to the first static series;
the flexible transmission element also forming a second succession of loops that respectively circumvent each pulley of the second static series and then each pulley of the second mobile series, and so forth, with the transmission element passing alternately between the second mobile series of pulleys and the second static series of pulleys; and
the flexible transmission element cooperating in driving manner with the rotary driving member of the flexible transmission elements and with the advance shaft.

27. The apparatus of claim 26, further comprising each of the mobile diverting elements is coupled in rotary driving manner with a pulley of each first series of mobile pulleys, and each static diverting element is coupled in rotary driving manner with a pulley of each first series of static pulleys.

28. A stamping station for depositing foil provided from at least one stamping foil onto a succession of sheet elements, comprising an apparatus according to claim 13.

29. A machine for processing sheet elements, the machine comprising a stamping station for depositing the sheet which is comprised of a foil supplied by a respective stamping foil, and the machine further comprising the apparatus according to claim 13.
